(19) United States
(12) Patent Application Publication
(10) Pub. No.: US 2025/0382905 A1
(43) Pub. Date: Dec. 18, 2025

(54) ADAPTIVE INTERNAL COMBUSTION ENGINE CYCLE SYSTEM FOR ENHANCED EFFICIENCY AND EMISSIONS REDUCTION

(71) Applicant: Derek A LaMarche, Arlington, WA (US)

(72) Inventor: Derek A LaMarche, Arlington, WA (US)

(21) Appl. No.: 19/226,203

(22) Filed: Jun. 3, 2025

Related U.S. Application Data
(60) Provisional application No. 63/659,966, filed on Jun. 14, 2024.

(51) Int. Cl. F01L 1/34; F01L 1/46; F01L 13/00

(52) U.S. Cl. CPC F01L 1/34; F01L 1/46; F01L 13/0015

(57) ABSTRACT

The present invention pertains to an advanced system for optimizing the performance of internal combustion engines (ICEs). It features the LaMarche Cycle, which dynamically adjusts valve timing, lift, and duration using magnetic actuators controlled by an electronic control unit (ECU). This system includes an integrated motor driver for precise force, position, speed, temperature, and power sensing, all encapsulated in epoxy for durability. It supports communication protocols such as RS485 and RS422 for seamless integration with external devices. The system offers real-time monitoring and control through a graphical user interface (GUI), enabling instant switching between operational modes to maximize fuel efficiency, power output, and reduce emissions. The design minimizes maintenance with lubrication-free bushings and versatile mounting options, including clevis/universal joints. This invention significantly enhances ICE efficiency, reduces emissions, and provides adaptable, user-friendly control for various applications.

### CROSS-REFERENCE TO RELATED APPLICATIONS

This application claims the benefit of U.S. Provisional Application No. 63/659,966, filed Jun. 14, 2024, entitled ADAPTIVE INTERNAL COMBUSTION ENGINE CYCLE SYSTEM FOR ENHANCED EFFICIENCY AND EMISSIONS REDUCTION, which is hereby incorporated by reference in its entirety.

### FIELD OF THE INVENTION

The present invention relates to the field of internal combustion engine technology, specifically to the development of advanced engine cycles that enhance fuel efficiency, maintain power output, and reduce emissions. It encompasses innovations in valve timing, engine control systems, and combustion processes designed to optimize engine performance under varying operational conditions.

### BACKGROUND

Internal combustion engines (ICE) have been a cornerstone of automotive and industrial machinery for over a century, powering a wide array of vehicles and equipment. The ongoing quest for improved engine efficiency, reduced fuel consumption, and lower emissions has led to the development of various engine cycles, each with its unique advantages and limitations. One notable engine cycle is the Miller cycle, patented by Ralph Miller in 1957. The Miller cycle distinguishes itself by modifying the intake valve timing. In this cycle, the intake valve remains open past the bottom dead centre (BDC) and continues to stay open during the initial part of the compression stroke. Specifically, the intake valve is kept open for roughly 20% of the upward stroke of the piston. This design choice lowers the effective compression ratio and reduces the volume of air within the cylinder, which in turn decreases the amount of fuel required for combustion.

While the Miller cycle demonstrated increased efficiency by reducing fuel consumption, it also presented certain drawbacks. The reduction in the compression ratio led to a decrease in engine power output, which was less desirable in an era that prioritized power over efficiency. Furthermore, keeping the intake valve open past BDC caused a portion of the intake charge to be expelled back into the intake manifold, resulting in a loss of potential energy, and contributing to overall inefficiency. Despite its innovative approach to improving efficiency, the Miller cycle did not gain widespread adoption at the time due to the trade-off between power and efficiency and the technological limitations of the period. However, the foundational concepts of the Miller cycle have continued to influence engine design, inspiring further research and development aimed at optimizing engine performance and efficiency.

In recent years, advancements in materials, electronics, and control systems have provided new opportunities to revisit and refine these earlier concepts. Modern engines benefit from precise control over various operational parameters, enabling more sophisticated strategies to enhance both efficiency and power while minimizing emissions. The ongoing evolution of internal combustion engine technology reflects a broader industry trend toward achieving a balance between performance, fuel economy, and environmental impact. As the demand for more efficient and cleaner engines continues to grow, there remains significant interest in developing innovative engine cycles that can meet these diverse and demanding requirements. Thus, the present invention relates to internal combustion engines (ICE) and aims to enhance their efficiency while maintaining the original power output. Specifically, the present invention introduces a novel cycle, termed the LaMarche cycle, which enables an engine to switch between different operational cycles to optimize efficiency, power, and emissions at the push of a button.

### BRIEF SUMMARY

The present invention pertains to an innovative approach to internal combustion engines (ICE) designed to significantly enhance efficiency while maintaining original power levels. This is achieved by enabling the engine to switch between different cycle styles to optimize efficiency, power, and emissions reduction, all at the push of a button. The core of the invention is the LaMarche Cycle. This cycle is a modified version of the Miller, Otto, and Atkinson cycles. Unlike the traditional Miller cycle, where the intake valve remains open past the bottom dead center (BDC) and starts to close during the upward stroke, the LaMarche Cycle closes the intake valve 0-50% before reaching BDC. This adjustment addresses the issue of intake charge being pushed back into the intake manifold, thereby improving efficiency by creating a vacuum in the last portion of the intake stroke. The engine has 20:1 compression and at 50% of the LaMarche cycle, it will be roughly 10:1 compression and thus one can run pump gasoline instead of racing gas.

The present invention employs magnetic actuators controlled by an Arduino system to manage the actuation speed, lift, duration, and timing of the valves. This advanced control mechanism overcomes the limitations of traditional camshaft-based systems, which are typically optimized for a specific RPM range. In conventional ICEs, camshaft profiles are fixed and usually tuned for highway efficiency. While other manufacturers have implemented variable valve technologies, these systems are essentially modifications of existing camshaft systems. In contrast, the present invention eliminates the need for camshafts and timing belts/chains. Instead, magnetic actuators provide precise and variable control over valve operation, allowing for a wide range of configurations. This capability enables the engine to operate in a highly efficient mode with low lift, short duration, and short timing, reducing fuel consumption and emissions. Conversely, it can switch to a high-power mode with high lift, long duration, and increased timing. This infinite variability also facilitates features such as true cylinder deactivation, rapid catalytic converter warming to reduce cold start emissions, and improved turbocharger performance by controlling exhaust flow.

The LaMarche Cycle enhances volumetric efficiency across all engine speeds. The system's ability to adjust valve lift and duration dynamically increases the intake charge and fuel-air mixing efficiency. This results in minimal power loss compared to the traditional Miller Cycle while retaining its fuel savings. The flexibility of this system allows for engines with high compression ratios for racing to be adjusted for regular street driving fuel standards. Magnetic linear actuators replace the sinusoidal motion of a camshaft with a near-square wave action, allowing for rapid valve opening and closing. This efficiency gain is due to the extended duration the valves remain fully open, maximizing air intake. Using an Electronic Control Unit (ECU), such as a Raspberry Pi, the system can finely tune valve operation to match engine demands, enhancing both low RPM efficiency and high RPM performance. This results in increased torque and horsepower availability.

The present invention comprises essential components such as magnetic actuators, the LaMarche Cycle, an Arduino for control, hall effect sensors, and a power supply capable of providing up to 40 amps at 12-60 volts. The ECU manages the actuator profiles, ensuring precise control over voltage and amperage to regulate actuation speed and force. The system's design is highly adaptable, with key parameters like linear actuation distance and force tailored to specific engine requirements.

The present invention provides a valve actuation system for internal combustion engines that eliminates the need for a mechanical camshaft and introduces a fully electronic, software-controlled approach to valve timing, lift, and duration. At its core, the system employs electromagnetic actuators, such as linear solenoids, which apply magnetic force directly or indirectly actuate the intake and/or exhaust valves. These actuators incorporate ferromagnetic core assemblies to guide magnetic flux efficiently, thereby improving actuation force and minimizing energy losses. The actuator motion is translated to valve movement through either direct-drive mechanisms or mechanical linkages, depending on engine configuration. Each actuator may be equipped with position feedback sensors, including Hall-effect or optical encoders, to report real-time position data to a microcontroller-based control unit, enabling closed-loop control of valve events with high precision. The control unit dynamically generates control signals that are modulated via a software logic system, which defines waveform profiles such as sine, square, or custom patterns. These profiles are adapted in real time using engine input parameters such as RPM, throttle position, intake manifold pressure, engine temperature, and knock sensor input. The system supports dynamic switching between multiple thermodynamic engine cycles, including Otto, Atkinson, Miller, and LaMarche, based on driving conditions. A power delivery system regulates current and voltage to the actuators through MOSFETs and drivers, ensuring responsive and safe operation, while a thermal management system, which may include heat sinks, fans, or liquid cooling, maintains stable operating temperatures. Additionally, the system enables cylinder-specific valve control for enhanced fuel efficiency and combustion optimization. It can implement selective cylinder deactivation, reduce turbo lag by adjusting exhaust valve profiles to manage flow velocity, and improve low-end torque by utilizing low-lift, short-duration valve profiles to increase air intake speed and mixture quality. For emission control, the system allows cold-start catalytic converter heating by advancing exhaust valve opening, reducing unburned hydrocarbon emissions. A user-configurable interface is provided, enabling manual or automated tuning of valve timing, lift curves, and operational modes via a graphical user interface. The entire system is mounted using robust, vibration-and heat-resistant mounting structures that ensure reliable performance in the engine environment. Communication with external systems is supported via standard digital interfaces, including RS485 or RS422, allowing integration with diagnostics, firmware updates, or real-time monitoring tools. The present invention discloses a highly adaptable, electronically controlled valve actuation system that replaces rigid mechanical constraints with real-time, software-defined functionality, improving engine efficiency, responsiveness, emissions control, and adaptability to diverse operational requirements.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIGS. 1-10 are diagrams that illustrate a linear motor and associated components for realizing a practical implementation, in accordance with an embodiment of the present subject matter.

FIG. 11 is a diagram that illustrates a system for adaptive internal combustion engine cycle for enhanced efficiency and emissions reduction, in accordance with an embodiment of the present subject matter.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items.

Before describing the present invention in detail, it should be observed that the present invention utilizes a combination of components or set-ups, which enhances internal combustion engine (ICE) efficiency while maintaining power by introducing the LaMarche Cycle with Infinity Valve Technology (IVT). It uses magnetic actuators controlled by an Arduino and an ECU to dynamically adjust valve timing, lift, and duration, allowing the engine to switch between different operational cycles for optimal performance, efficiency, and reduced emissions at the push of a button. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

In an embodiment, the disclosed actuation system comprises actuators configured to operate intake and/or exhaust valves of the engine without a mechanical camshaft. In an embodiment, the disclosed actuation system comprises a control unit configured to generate control signals for the actuators to variably adjust valve lift, duration, and timing based on operating conditions of the engine. In an embodiment, the disclosed actuation system comprises a software-defined modulation system configured to dynamically adjust the control signals based on real time inputs to support multiple valve actuation profiles. The system enables transition between different engine operating modes to selectively optimize power output, fuel efficiency, or emissions.

In an embodiment, each electromagnetic actuator includes a ferromagnetic core configured to direct magnetic flux and enhance actuation efficiency. The actuators are linear solenoids configured to produce direct axial motion to open or close a valve. In an embodiment, the system includes a position feedback mechanism configured to provide real-time valve or actuator position data to the control unit. In an embodiment, the control unit uses one or more engine operating parameters selected from engine speed, load, throttle position, intake manifold pressure, engine temperature, and knock detection (by knock sensor). The control unit is configured to selectively implement valve actuation profiles corresponding to Otto, Atkinson, Miller, or LaMarche engine cycles. In an embodiment, the software-defined modulation system applies variable waveform profiles, including square, sine, or custom modulated signals, to actuate the valves. In an embodiment, the system further includes a power management system configured to modulate current and voltage supplied to each actuator based on timing and load. In an embodiment, the system further includes a cooling system configured to dissipate heat generated by the actuators during operation. In an embodiment, the system enables cylinder-specific control, allowing individual cylinder to operate with different valve profiles based on real-time requirements, and wherein the system is configured to support selective cylinder deactivation by disabling actuation of selected valves. In an embodiment, the control unit includes a user-configurable interface to allow manual or automated tuning of valve profiles.

The present invention will now be described with reference to the accompanying drawings which should be regarded as merely illustrative without restricting the scope and ambit of the present invention.

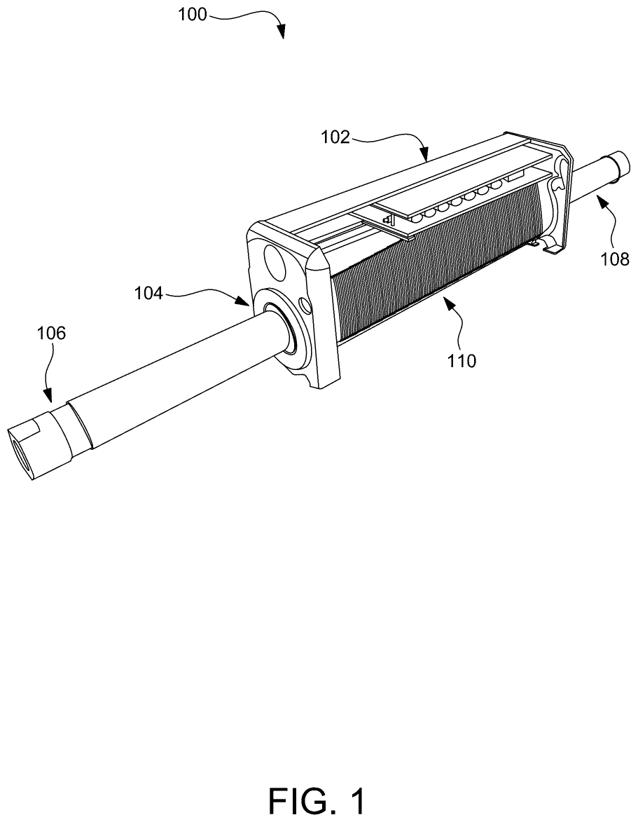

FIGS. 1-10 are diagrams that illustrate a linear motor and associated components for realizing a practical implementation, in accordance with an embodiment of the present subject matter.

FIG. 1 is a diagram 100 that illustrates the components and features of an advanced linear actuator system, highlighting various technical aspects and their associated benefits. The system includes an integrated motor driver 102. The motor driver is encapsulated in epoxy for protection and integrates functionalities such as force, position, speed, temperature, and power sensing. This provides precise control over the actuator's movements and ensures optimal performance and reliability. By incorporating sensors and control electronics within the actuator, precise and responsive adjustments can be made, improving the actuator's overall functionality. The actuator is equipped with a shielded IP68 cable gland with flying leads, indicating it is highly resistant to dust and capable of withstanding immersion in water. This makes the actuator suitable for harsh environments. IP68 rating ensures the actuator is dust-tight and water-resistant, making it ideal for use in demanding environments where exposure to contaminants is likely. The system further includes replaceable bushings 104. The use of lubrication-free bushings ensures smooth and maintenance-free operation. These bushings reduce friction and wear, enhancing the longevity and efficiency of the actuator. These bushings reduce the need for maintenance and provide consistent performance by eliminating the requirement for periodic lubrication. The system further includes a threaded shaft end 106. The shaft end has ½″-20×1″ threads, allowing for easy and secure attachment to other components or systems. This threaded connection facilitates integration into various applications. The system further includes a shaft 108. The shaft is made of polished stainless steel, providing durability, corrosion resistance, and a smooth surface for reliable operation. The system further includes a 4-phase air core stator 110. This component is designed to offer rapid and smooth operations without cogging (torque ripple). The air core stator, which lacks an iron core, reduces weight, and increases efficiency by minimizing magnetic losses. The use of an air core stator eliminates the iron core, reducing eddy current losses and hysteresis, resulting in smoother operation and improved efficiency. The four-phase configuration enhances the actuator's precision and control.

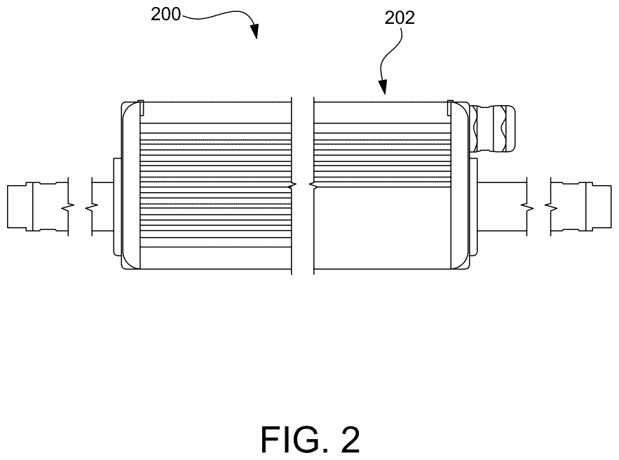

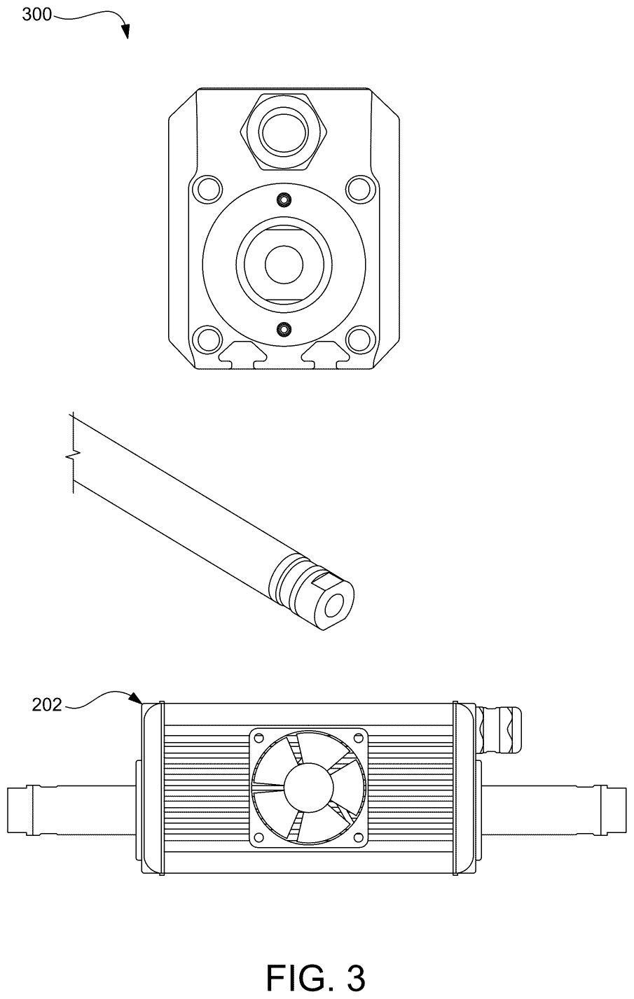

FIGS. 2 and 3 are schematic line diagrams 200 and 300 that illustrate the linear motor 202. Linear motors 202 have been designed to deliver performance characterized by ultra-low latency and quiet operation, making them suitable for applications requiring precision and subtlety. These motors 202 offer a low total cost of ownership due to their efficient design and minimal maintenance requirements. The force-controlled nature of these motors 202 makes them ideal for scenarios involving human-machine interaction, ensuring safe and responsive operation. One of the standout features of these linear motors 202 is their all-in-one design. Each motor 202 comes with integrated drivers, power delivery systems, logic controls, and sensing capabilities. This eliminates the need for additional controllers, simplifying installation and reducing overall system complexity. Each motor 202 includes a motor driver that is encapsulated to meet IP68 standards, providing protection against dust and water, thus ensuring reliable performance even in harsh environments. The motors 202 further come equipped with sensors that allow for precise position and force measurements. This integration enables high-accuracy control and responsiveness. Further, these motors 202 can rapidly adjust force and position, which is essential for applications requiring quick and precise movements. Further, these motors 202 have been designed for silent operation, therefore, these motors 202 are perfect for environments where noise reduction is crucial. The motors 202 operate on low voltage direct current (DC), enhancing safety and making them easier to integrate with existing systems. With only one moving part, the motors are inherently reliable and have a lower risk of mechanical failure. The motors 202 use robust RS485 communication protocols, ensuring reliable data transmission even in noisy industrial environments. These motors 202 can be back driven with minimal force ripple, making them smooth and easy to control manually when needed. The design and construction of these motors minimize the need for regular maintenance, contributing to their low total cost of ownership. With their integrated systems and straightforward design, these motors are easy to set up and operate, making them accessible for a wide range of applications.

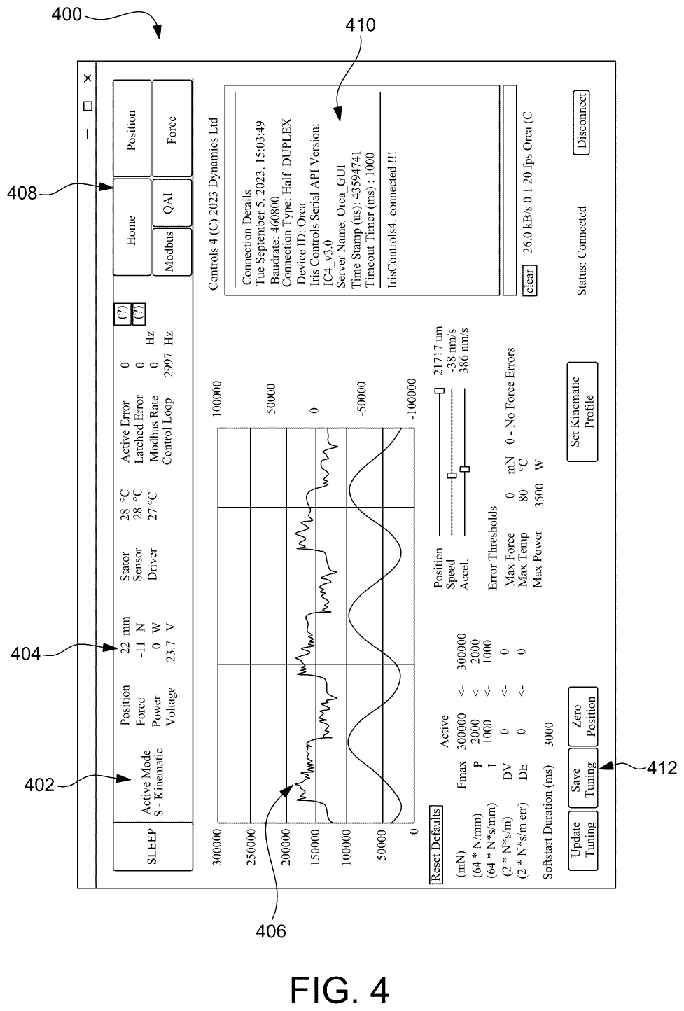

FIG. 4 illustrates a drawing that depicts a graphical user interface (GUI) 400 designed for controlling and monitoring a linear motor system. The interface provides comprehensive real-time data and control options. It features status indicators 402 displaying the system's current state, such as “Active Mode” and a “Status (Red)” alert indicating an error condition. Real-time readings 404 for position (22 mm), force (−11 N), power (−5 W), and voltage (23.7 V) are prominently shown. The GUI 400 includes graphical data displays 406 with real-time plots of various parameters. The top graph represents position or force data, while the bottom graph shows another parameter, motor current or a sinusoidal reference signal. Users can adjust key settings 408 such as position, force, and rotation speed, and configure error thresholds for parameters like maximum force (2000 N) and position (3900 mm), ensuring safe operation.

As shown, the connection details 410 are also provided, including the connection status, device ID, server name, and data rate. Additional motor data, such as sensor temperatures, error counts, maximum rates, and frequencies, are also displayed. The interface includes control actions 412 such as “Update Timing,” “Save Tuning,” “Zero Position,” and “Set Regenerative Profile,” which allow users to perform specific actions related to motor control and configuration.

Further, the environmental data, such as temperature and system status, along with the connection status, indicated as “Connected” are also featured. This GUI 400 serves as a powerful tool for operators, enabling them to manage the motor system effectively through a blend of real-time monitoring, precise control, and configurable settings. The graphical plots provide visual feedback on the system's behavior, allowing for quick identification of anomalies or performance issues, thus ensuring optimal performance and safety.

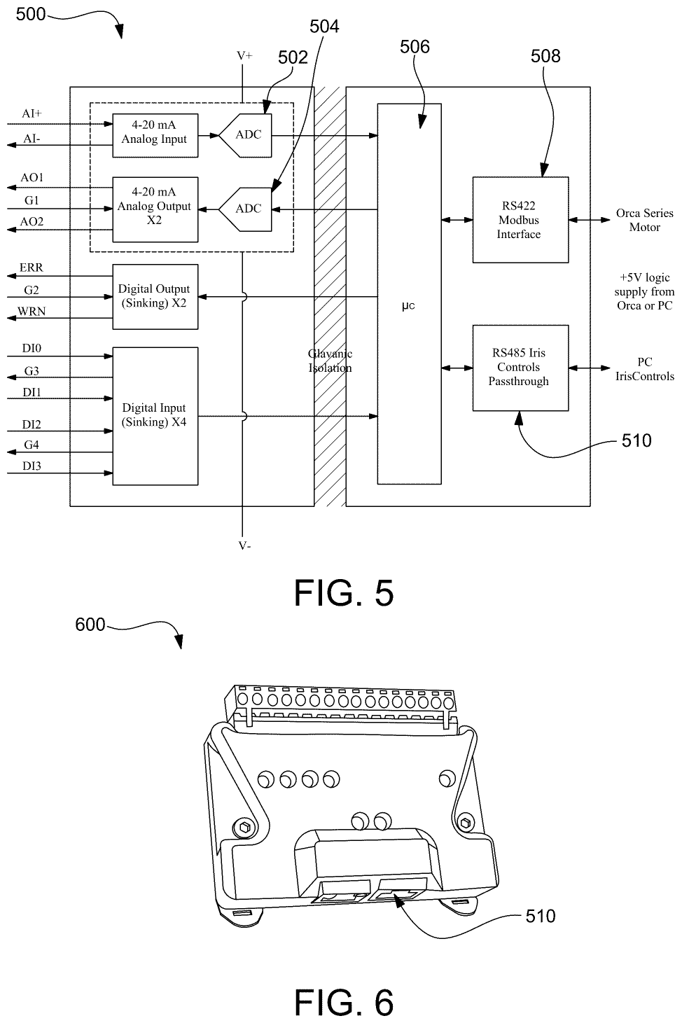

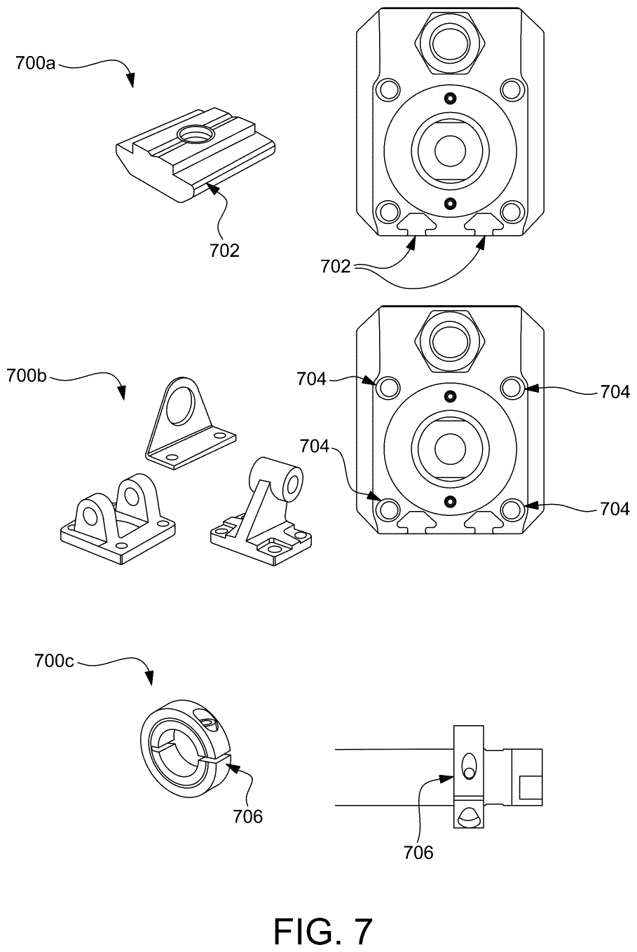

FIGS. 5 and 6 are drawings 500 and 600 that illustrate the Orca IO SmartHub™ (IOSH), a versatile control module designed for use with the motors. The diagram illustrates the internal architecture of the JOSH. The analog input (4-20 mA) is processed by an Analog-to-Digital Converter (ADC) 502, while the analog outputs are managed by a Digital-to-Analog Converter (DAC) 504. Digital inputs and outputs are galvanically isolated from the motor control circuitry, enhancing system robustness and safety. The microcontroller (μC) 506 at the core of the IOSH manages data processing and communication. It interfaces with the motor through the RS422 Modbus interface 508 and communicates with external devices or software via the RS485 IrisControls Passthrough 510. The inclusion of error and warning signal outputs allows for real-time monitoring and troubleshooting.

In an embodiment, the JOSH enables precise control of motor functions through analog or digital signals, providing a straightforward and robust interface for managing position targets or force outputs. It can also trigger pre-programmed paths stored in the motor, making it ideal for applications requiring automated and programmable motion control. The module features separate 4-20 mA outputs for position and force feedback, along with a digital error and warning signal, ensuring reliable performance and easy integration with various IO devices such as simple switches, PLCs, and microcontrollers.

In an embodiment, the JOSH includes one 4-20 mA or 0-20 mA input and two 4-20 mA or 0-20 mA outputs, allowing for versatile signal interfacing. Additionally, it features two 24 V (sinking) digital outputs and four 24 V (sinking) digital inputs, accommodating a wide range of control and feedback configurations. Further, there is also provided galvanic isolation. This feature provides electrical isolation between the PLC and the motor, protecting the system from electrical noise and potential damage due to voltage differences. The users can adjust the input and output ranges and sensitivity, tailoring the system to specific application requirements. Further, the device operates within a 5-30 V supply range, making it compatible with various power sources. With a 2250 Hz sampling rate, the JOSH ensures rapid and accurate data acquisition, crucial for precise motor control. The module supports RS422 Modbus and RS485 IrisControls Passthrough interfaces, facilitating reliable communication with other system components and software.

FIG. 7 shows diagrams 700a, 700b, and 700c that illustrates components such as a T-slot mounting 702, a pneumatic tube mounting 704, and a shaft collar 706. In an embodiment, the T-slot mounting 702 utilizes 1-inch T-slots that run along the bottom of the motors, accommodating various mounting arrangements. This method is particularly versatile, allowing for easy and secure attachment to different surfaces or structures. The provided dimensions indicate a slot width (d) of 25.4 mm (1 inch) and a height (h) of 32 mm (1.26 inches). The accompanying illustration shows the T-slot integrated into the motor base, demonstrating how it can be used to affix the motor securely in place. This type of mounting is ideal for applications requiring adjustable positioning or frequent reconfiguration.

In an embodiment, the pneumatic tube mounting 704 features ISO15552 50 mm pneumatic tube mounting patterns, compatible with a variety of widely available mounting hardware. This mounting method ensures compatibility with standard pneumatic equipment, making it suitable for applications where integration with pneumatic systems is necessary. The specified dimension for this mounting pattern is a diameter (d) of 46.5 mm (1.83 inches). The figure includes examples of compatible mounting hardware, such as brackets and mounts, and a schematic showing the mounting points on the motor face. This approach is robust and ensures secure and stable mounting, ideal for industrial environments.

In an embodiment, the shaft collar 706 is a mechanical component used to secure or position components on a shaft. The dimensions provided include an inner diameter (ID) of 25 mm, an outer diameter (OD) of 45 mm, a width(s) of 12.7 mm (0.5 inches), and an overall diameter (d) of 35 mm (1.38 inches). The illustrated shaft collar features a clamping mechanism that ensures a tight and secure fit around the shaft, preventing slippage. This component is critical in applications where precise axial positioning is necessary, such as in the alignment of gears, bearings, and other rotational components. The diagram demonstrates the collar clamped onto a shaft, highlighting its role in maintaining component stability.

These mounting options provide flexible and reliable solutions for integrating motors into various mechanical systems. T-Slot mounting offers adjustability, pneumatic tube mounting ensures compatibility with standard pneumatic systems, and the shaft collar provides precise axial positioning. Each method is supported by detailed dimensions and illustrations to guide proper implementation.

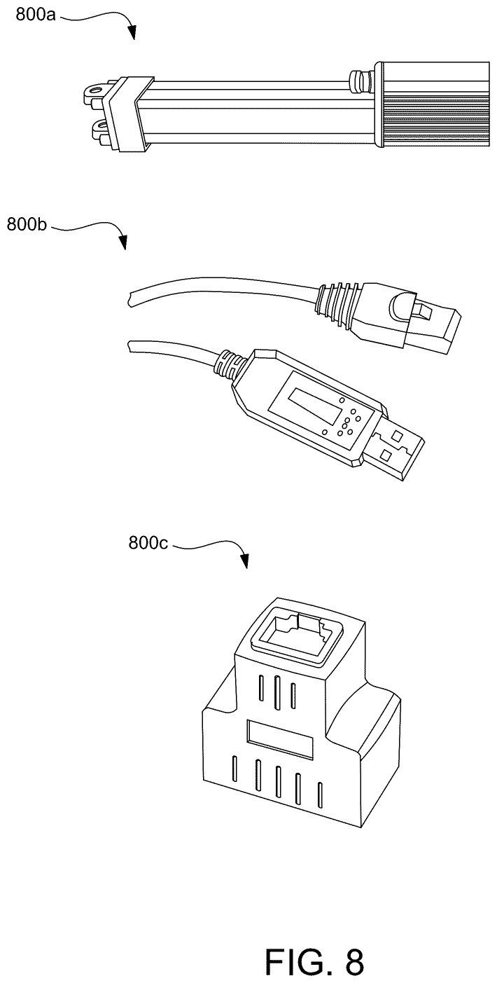

FIG. 8 illustrates accessories such as rear tubes 800a, USB cables 800b, and a RJ splitter 800c. In an embodiment, the rear tubes 800a are cylindrical components used in the assembly of the motors, providing structural support and housing for the internal mechanisms. The tubes are made from aluminum, a material known for its lightweight and high strength, making them suitable for demanding applications. The specified sizes include an inner diameter (ID) of 50 mm and an outer diameter (OD) of 55 mm, indicating the thickness and robustness of the extrusion. Custom lengths for these rear tubes can be requested by contacting the provided sales email, allowing for tailored solutions to fit specific project requirements.

In an embodiment, the USB cables 800b are essential for connecting the motors to control systems and computers, facilitating data transfer and command execution. The USB-to-RS485 cable converts USB serial port data to the half-duplex RS485 industrial signals used by the devices. It enables connection to IrisControls, providing access to the graphical user interface (GUI) and allowing for firmware upgrades. This cable is crucial for integrating the motors with PC-based control systems, ensuring smooth communication and control. The USB-to-RS422 cable converts USB serial port data to the full-duplex RS422 industrial signals, which supports more extensive data communication capabilities. It allows forces, positions, and motions to be commanded directly from operating systems like Windows, MacOS, or Linux without needing an intermediate controller. This cable provides a more robust and flexible connection, suitable for complex and high-demand applications.

In an embodiment, the RJ splitter 800c is an accessory designed to facilitate the use of both Modbus and IrisControls interfaces simultaneously. This component allows easy connection to a shared RJ45 connector, optimizing the setup and integration process. The splitter measures 14 mm×40 mm×20 mm and features one RJ45 female port on one side and two RJ45 female ports on the other. The single port connects to the motor cable, while the dual ports accommodate different interfaces. This splitter is essential for setups requiring simultaneous access to multiple control interfaces, ensuring seamless and efficient communication between the motor and various control systems.

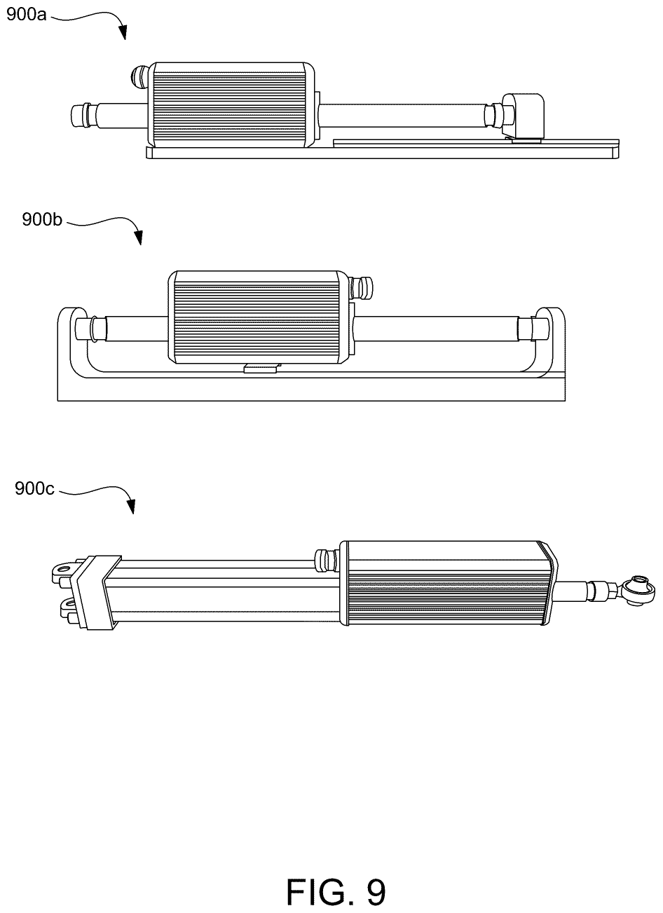

FIG. 9 illustrates mounting options such as a moving shaft 900a, a moving stator 900b, and a clevis/universal joint 900c. In the moving shaft configuration 900a, the stator remains stationary while the shaft itself actuates the load. This setup is advantageous when the actuator needs to directly move an attached component or load. The fixed stator provides a stable base, allowing the shaft to extend and retract with precision. This configuration is commonly used in applications where the load needs to be moved along a linear path, and the stability of the stator helps in achieving accurate and controlled motion.

The moving stator configuration 900b operates with the shaft fixed at both ends, while the stator itself moves along the shaft. This setup can accommodate multiple stators installed along a single shaft if the application demands it. Moving stators are particularly beneficial in scenarios where space constraints or length restrictions are a concern. By having the stator move instead of the shaft, the system can be more compact and flexible in terms of installation and operation. This configuration is ideal for applications that require distributed motion along the length of the shaft, providing versatility and adaptability.

The clevis/universal joint 900c offers an additional mounting capability using an optional rear shaft cover. This cover allows the actuator to be mounted with ISO 15552 50 mm pneumatic tube attachments, enabling the line of action to move with the load. This is especially useful for replacing traditional lead screws or pneumatic actuators. The rear shaft cover can be customized to match the desired shaft length, and the optional rear plate can be modified or removed to accommodate specific mounting hardware. This configuration provides flexibility in mounting and integration, making it suitable for a wide range of industrial and mechanical applications where precise and adaptable movement is required.

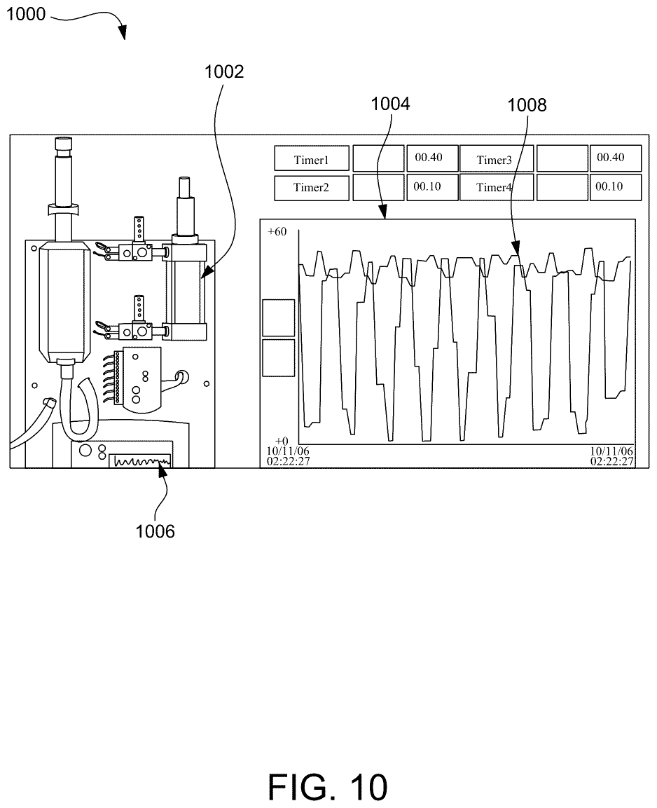

FIG. 10 illustrates a drawing 1000 that depicts a practical implementation of a control system featuring a pneumatic actuator and an electronic control interface. The setup includes a physical arrangement of the actuator 1002 and a digital interface 1004 displaying real-time performance data. Each component plays a crucial role in demonstrating the functionality and monitoring capabilities of the system.

The pneumatic actuator 1002 uses compressed air to generate mechanical motion, typically linear, to control various mechanical processes. It is mounted on a metal frame, ensuring stability and proper alignment. The pneumatic actuator's design includes a piston and cylinder mechanism, where the introduction or release of compressed air moves the piston, thereby extending or retracting the actuator's rod. This type of actuator 1002 is widely used in industrial automation for tasks requiring rapid and precise linear motion. The robust construction and reliable performance make pneumatic actuators 1002 ideal for repetitive operations in manufacturing and process control. There is further shown the control system 1006 comprising electronic components and connectors. This system 1006 includes indicators and connectors, representing power supply connections, control signals, and feedback loops. The control system 1006 is essential for managing the actuator's operation, including controlling the air flow, regulating the actuator's speed and position, and ensuring safe operation through feedback mechanisms. The presence of lights and connectors indicates real-time operational status and facilitates easy connection and maintenance. The digital interface 1004 provides a graphical representation of the system's performance. The screen displays real-time data, including timer settings and a graph showing the position or performance of the actuator over time. The graph 1008 features a series of peaks and troughs, indicating the actuator's movement cycles. The interface includes several timers (Timer1, Timer2, Timer3, and Timer4), which are set to specific durations, indicating the precise control over the actuator's operational periods. This interface is crucial for monitoring the actuator's behavior, diagnosing issues, and making adjustments to optimize performance. The combined setup of the pneumatic actuator, control system, and digital interface exemplifies a well-integrated automation solution. The pneumatic actuator provides the necessary mechanical motion, while the control system ensures accurate and responsive operation through real-time adjustments and feedback. The digital interface allows operators to monitor and control the system efficiently, ensuring optimal performance and quick response to any anomalies. This integration highlights the synergy between mechanical components and electronic controls, essential for modern industrial automation.

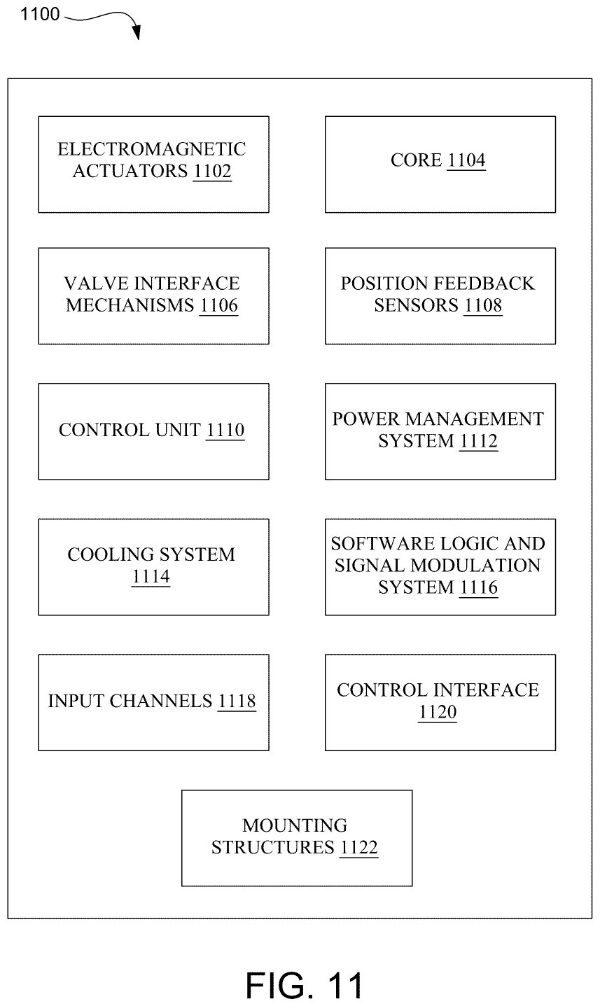

FIG. 11 is a diagram that illustrates a system 1100 for adaptive internal combustion engine cycle for enhanced efficiency and emissions reduction, in accordance with an embodiment of the present subject matter. The system 1100 includes electromagnetic actuators 1102, core assemblies 1104, valve interface mechanisms 1106, position feedback sensors 1108, a control unit 1110, a power management system 1112, a cooling system 1114, a software logic and signal modulation system 1116, input channels 1118, a control interface 1120, and mounting structures and engine integration hardware 1122.

The electromagnetic actuators 1102 replace the conventional camshaft-driven mechanisms that control the opening and closing of the intake and exhaust valves in an ICE. The actuator 1102 uses an electromagnetic coil to generate a magnetic field, which applies force to a movable element, typically a plunger or armature, to initiate valve movement. By precisely controlling the strength, timing, and duration of the magnetic pulse, the actuator 1102 opens and closes the valve in real time, based on dynamic engine demands. Unlike mechanical camshafts, this method eliminates parasitic drag, allows highly variable valve operation (lift, timing, and duration), and supports rapid transitions between operating modes such as high-performance and fuel-efficient cycles.

Each actuator 1102 incorporates the ferromagnetic core 1104, which can be made of laminated or solid ferromagnetic material. The core 1104 provides an efficient magnetic path to channel magnetic flux generated by the coil. Its role is to contain and direct the magnetic field to the actuator's moving element, ensuring efficient generation of linear force. The design minimizes magnetic hysteresis and heat loss while maximizing the responsiveness of valve actuation. Laminated cores 1104 are especially beneficial in high-frequency switching applications, helping to reduce eddy current losses and improve thermal behavior. In the present invention, this ensures rapid valve actuation with minimal energy waste, enabling sustained high-speed operation under varying engine loads.

The valve interface mechanisms 1106 translates the linear motion of the electromagnetic actuator 1102 into the physical opening or closing of the engine's valves. Depending on design constraints, the translation may be direct (e.g., actuator plunger pushing valve stem) or via linkages or rocker arms. The interface is engineered to maintain alignment, minimize backlash, and ensure consistent mechanical response. In the context of the present invention, the interface allows full control of valve lift and timing without the limitations imposed by fixed camshaft profiles. It enables programmable valve behavior tailored to each cylinder's operating condition, supporting functions such as cylinder deactivation, variable displacement, and advanced scavenging strategies.

Real-time feedback on valve or actuator position is essential for precise control. Hall-effect sensors or optical encoders 1108 are used to continuously monitor the actuator's position and valve lift. These sensors 1108 close the control loop, providing real-time data to the control unit, which adjusts coil current and duration to achieve the desired motion profile. The feedback ensures accurate synchronization of valve events with crankshaft rotation and enables adaptive correction for thermal expansion, mechanical wear, or transient load variations. In the present invention, this sensor feedback is crucial for achieving consistent combustion efficiency, emissions control, and responsive transitions between power modes.

The control unit 1110 is a microcontroller or microprocessor system that receives real-time inputs such as RPM, throttle position, intake manifold pressure, and knock signals, and translates them into precise control signals for each actuator. It modulates current waveforms (e.g., square, sine, or custom waveforms) to achieve desired valve events. The control unit 1110 operates in synchronization with engine crankshaft position, ensuring correct valve phasing. In the present invention, the control unit 1110 also manages multi-mode operation, such as switching between LaMarche cycle, Atkinson, Otto, or Miller-style cycles, thereby optimizing the engine's performance across a broad range of operating conditions.

The power management system 1112 includes current regulators, MOSFETs, drivers, and energy recovery circuitry to ensure each actuator 1102 receives the correct voltage and current at the right time. It may deliver high currents (potentially up to 40 amps) in controlled pulses, while protecting against thermal overload and power surges. Smart regulation ensures energy-efficient operation and prolongs component life. In the present invention, the power management system 1112 supports high-speed actuation across all operating conditions, coordinating with cooling and feedback systems to maintain safe and efficient actuator performance.

The actuators, cores, and power electronics generate significant heat during continuous operation. To manage this, the system includes the cooling system 1114, which may be passive (heat sinks, thermal paths) or active (forced air or liquid cooling). Proper thermal management prevents overheating, maintains coil resistance within designed ranges, and ensures consistent magnetic force output. In this system, efficient cooling ensures that high-speed valve actuation can be maintained without thermal degradation, allowing long-term durability and sustained high-RPM operation.

The software logic and signal modulation system 1116 is a software-defined modulation system, which defines how valves behave under varying engine conditions. It comprises software algorithms that generate modulated waveforms (sine, square, trapezoidal, etc.) for actuating the valves and adapting lift, duration, and timing dynamically. The software operates based on engine maps, sensor inputs, and real-time demands. It enables seamless mode-switching (e.g., between economy and performance profiles), ensures low-lift high-velocity flow at low RPMs for complete combustion, and high-lift, long-duration opening at high RPMs for power output. The flexibility offered by software control sets this system apart from conventional VVT mechanisms, which rely on mechanical or hydraulic actuation.

The input channels 1118 include interfaces to common engine sensors such as crankshaft position (CKP), throttle position sensor (TPS), manifold absolute pressure (MAP), intake air temperature (IAT), knock sensors, and oxygen sensors. These inputs feed real-time operational data into the ECU, allowing the system to respond instantly to changes in driving conditions. In the present invention, this real-time data ensures that valve events are precisely coordinated with combustion requirements, improving responsiveness, reducing fuel waste, and lowering emissions.

The control interface 1120 includes a user-facing interface (e.g., touch screen or computer-based GUI) that allows engineers or users to adjust parameters like lift curves, timing profiles, and operational modes. This interface 1120 may allow both manual tuning and automated calibration based on operating scenarios. In the present invention, the interface 1120 enables fine-grained control for prototyping, racing, or adaptive learning scenarios where the engine behavior needs to be customized based on environment, driver preference, or fuel type.

Various components, such as actuators, sensors, cooling elements, and control electronics, require robust mounting hardware for secure attachment to the engine head or frame. These structures must withstand engine vibration, thermal cycling, and long-term mechanical stresses. In the present invention, tailored brackets, thermal insulators, and vibration-dampening mounts 1122 ensure reliable integration within existing or redesigned ICE architectures, supporting retrofits or new engine designs.

The operation involves a coordinated, real-time control system that replaces traditional camshaft-based valve actuation in internal combustion engines (ICEs) with a fully electronic and software-defined electromagnetic valve control system. At the core of this system are the electromagnetic valve actuators 1102, which generate magnetic force to open and close intake and exhaust valves without any mechanical camshaft. These actuators 1102 are powered by high-speed magnetic coils wrapped around ferromagnetic core assemblies, which efficiently channel magnetic flux to produce linear motion with high force and minimal energy loss. As the magnetic field is energized, the actuator 1102 moves a plunger that is mechanically coupled through a valve interface mechanism, either directly or via a linkage, to the valve stem, controlling valve lift and duration. To ensure precise actuation, each actuator 1102 is equipped with the position feedback sensors 1108, such as Hall-effect or optical encoders, which provide real-time data on the valve's exact position. This feedback is sent to the microcontroller-based control unit 1110, which uses it to dynamically adjust the actuation signal. The control unit 1110 processes multiple real-time input signals, including engine RPM, throttle position, intake manifold pressure (MAP), knock signals, and engine temperature, and uses this data to determine the optimal valve event profile. It then generates modulated signals (configurable as square, sine, or custom waveforms) that determine when and how long each valve should open or close. This allows for true closed-loop control of each cylinder's airflow, tailored to current engine demands. Further, supporting this control logic is the power management system 1112 that precisely regulates voltage and current delivered to each actuator 1102. This system incorporates current regulators, MOSFETs, and signal drivers to prevent overheating, ensure safe operation, and provide the required electrical power at the precise moment. To maintain thermal stability, the system includes the cooling system 1114, which can be passive (e.g., heat sinks) or active (e.g., liquid or forced air), dissipating heat generated by continuous and rapid electromagnetic switching. This ensures that actuator performance remains stable even under high-RPM or high-load conditions. Further, the software logic and modulation system 1116 governs the overall valve behavior through programmable lift, timing, and duration profiles. These profiles can be dynamically switched on-the-fly based on engine needs, enabling modes such as high-efficiency low-lift operation for fuel economy, or high-lift long-duration operation for maximum performance. Additionally, this system can simulate the characteristics of different thermodynamic engine cycles (e.g., Otto, Atkinson, Miller, LaMarche) by adjusting valve timing characteristics dynamically.

Further, the user-adjustable interface 1120, accessible via a GUI or touchscreen, allows tuning of engine behavior, either manually or through automated scripts. The users can modify valve lift curves, define power or economy modes, or test custom profiles for development or racing purposes. All components are integrated using mounting structures and engine integration hardware designed to withstand the vibrations, heat, and stresses of the engine environment. Finally, a communication interface using RS485 or RS422 protocols connects the system to external diagnostics or tuning software, enabling real-time monitoring and firmware updates. The present invention delivers precise, programmable, and highly responsive valve control unmatched by mechanical systems. It eliminates camshaft-related losses, allows infinite variability of valve events, improves combustion efficiency, reduces emissions, and adapts in real-time to driver input and engine load. This represents a transformative upgrade to traditional ICE architecture, enabling future-ready performance, adaptability, and environmental compliance.

The disclosed invention brings numerous advantages to the field of internal combustion engines (ICEs) by integrating advanced control systems and innovative mechanical designs. It enhances efficiency and power control, allowing dynamic switching between different cycle styles for optimized performance, fuel savings, and reduced emissions. The precise control over valve timing, lift, and duration, managed by magnetic actuators and an ECU, results in higher volumetric efficiency across all engine speeds. The engine may have 20:1 compression, and at 50% of the LaMarche cycle, it will be roughly 10:1 compression and thus one can run pump gasoline instead of racing gas. Environmental benefits include significantly lowered hydrocarbon and NOx emissions and the ability to warm up the catalytic converter quickly, reducing cold start emissions. The system's flexibility allows for fuel tuning, enabling high compression ratios for racing fuel and adjustments for regular street fuel. Operationally, it offers instantaneous adjustments between maximum power and high efficiency, improved turbocharger performance without lag, and robust communication through RS485 and RS422 interfaces, ensuring reliable integration with existing control systems. Maintenance is minimized with the elimination of traditional camshafts and timing belts/chains, lubrication-free bushings, and a low-maintenance design. The versatile mounting options, such as T-slot, pneumatic tube, and clevis/universal joint, facilitate easy installation in various applications. A user-friendly graphical interface provides real-time monitoring and control, enhancing user experience and safety with features like error thresholds and detailed feedback. Finally, the system ensures safety and reliability with galvanic isolation between the PLC and motor and an integrated motor driver, encapsulated in epoxy, capable of withstanding harsh environments. Overall, this invention significantly advances ICE technology by delivering superior efficiency, reduced emissions, operational flexibility, and ease of use and maintenance.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the claims. Thus, it is intended that the present invention cover the modifications and variations of this invention, provided they are within the scope of the claims and their equivalents.

1. A system for optimizing the performance of an internal combustion engine (ICE), comprising:
actuators configured to control the intake and exhaust valves of the ICE;
a control unit configured to dynamically adjust timing, lift, and duration of the intake and exhaust valves based on engine operating conditions; and
an adaptive engine cycle, wherein the intake valve is configured to close 0-50% before the bottom dead centre (BDC) to create a vacuum and enhance volumetric efficiency,
wherein the system is capable of switching between different operational modes to optimize fuel efficiency, power output, and emissions at a push of a button.

2. The system of claim 1, further comprising lubrication-free bushings in the actuators to reduce maintenance requirements and improve durability.

3. The system of claim 1, further comprising a communication interface for connecting the control unit to external control devices, supporting RS485 and RS422 communication protocols.

4. The system of claim 1, further comprising an integrated motor driver encapsulated in epoxy for force, position, speed, temperature, and power sensing, wherein the integrated motor driver is rated for IP68, providing protection against dust and water ingress.

5. The system of claim 1, further comprising a graphical user interface (GUI) for real-time monitoring and control of the engine parameters.

6. The system of claim 5, wherein the GUI includes real-time graphical plots of engine parameters such as position, force, and operational cycles, and allows for setting error thresholds and control profiles for different operating conditions.

7. An actuation system for an internal combustion engine (ICE), comprising:
actuators configured to operate intake and/or exhaust valves of the engine without a mechanical camshaft;
a control unit configured to generate control signals for the actuators to variably adjust valve lift, duration, and timing based on operating conditions of the engine; and
a software-defined modulation system configured to dynamically adjust the control signals based on real-time inputs to support multiple valve actuation profiles,
wherein the system enables transition between different engine operating modes to selectively optimize power output, fuel efficiency, or emissions.

8. The system of claim 7, wherein each electromagnetic actuator includes a ferromagnetic core configured to direct magnetic flux and enhance actuation efficiency, and wherein the actuators are linear solenoids configured to produce direct axial motion to open or close a valve.

9. The system of claim 7, wherein the system includes a position feedback mechanism configured to provide real-time valve or actuator position data to the control unit.

10. The system of claim 7, wherein the control unit uses one or more engine operating parameters selected from engine speed, load, throttle position, intake manifold pressure, engine temperature, and knock detection, and wherein the control unit is configured to selectively implement valve actuation profiles corresponding to Otto, Atkinson, Miller, or LaMarche engine cycles.

11. The system of claim 7, wherein the software-defined modulation system applies variable waveform profiles, including square, sine, or custom modulated signals, to actuate the valves.

12. The system of claim 7, further comprising a power management system configured to modulate current and voltage supplied to each actuator based on timing and load.

13. The system of claim 7, further comprising a cooling system configured to dissipate heat generated by the actuators during operation.

14. The system of claim 7, wherein the system enables cylinder-specific control, allowing individual cylinder to operate with different valve profiles based on real-time requirements, and wherein the system is configured to support selective cylinder deactivation by disabling actuation of selected valves.

15. The system of claim 7, wherein the control unit includes a user-configurable interface to allow manual or automated tuning of valve profiles.
